(19) United States
(12) Patent Application Publication
(10) Pub. No.: US 2023/0170712 A1
(43) Pub. Date: Jun. 1, 2023

(54) CHARGING CELLS IN A BATTERY PACK

(71) Applicant: Cirrus Logic International Semiconductor Ltd., Edinburgh (GB)

(72) Inventors: John P. LESSO, Edinburgh (GB); Anthony S. DOY, Bend, OR (US)

(73) Assignee: Cirrus Logic International Semiconductor Ltd., Edinburgh (GB)

(21) Appl. No.: 17/988,299

(22) Filed: Nov. 16, 2022

Related U.S. Application Data
(60) Provisional application No. 63/283,592, filed on Nov. 29, 2021.

(30) Foreign Application Priority Data
Feb. 11, 2022 (GB) 2201764.4

(51) Int. Cl. H02J 7/00

(52) U.S. Cl. CPC H02J 7/0024

(57) ABSTRACT

A battery pack comprising: a set of N parallel-coupled switched cell strings, each switched cell string comprising a cell and a switch for selectively coupling a first terminal of the cell to a first terminal of the battery pack.

### FIELD OF THE INVENTION

The present disclosure relates to charging cells in a battery pack.

### BACKGROUND

Battery packs are used in a wide variety of applications to provide electrical power. For example, portable devices (e.g. laptop computers, cordless power tools and the like) and larger devices such as electric scooters, wheelchairs and bicycles may include a rechargeable battery pack to power the device. One of the largest areas of growth in demand for battery packs is electric vehicles (EVs), such as electric cars, vans, motorcycles, goods vehicles etc.

A battery pack is typically made up of a number of connected modules, each containing a plurality of individual cells that are connected together in series, parallel or series/parallel combinations in order to achieve a desired nominal output voltage and battery capacity.

FIG. 1a is a simplified schematic representation of an example battery pack. As shown, the battery pack 100a in this example comprises four modules 110 - 140 connected in parallel between positive and negative output terminals 150, 160. Each module 110 - 140 in this example comprises four individual cells (e.g. 112 - 118) connected in series.

By way of example, if each individual cell has a nominal capacity of 550 mAh (i.e. drawing a current of 550 mA from a fully charged cell for one hour would completely discharge the cell) and a nominal voltage of 1.2 v, the nominal output voltage of each module 110 - 140 in the FIG. 1a example will be 4 × 1.2 v = 4.8 v, and the nominal capacity of each module 110 - 140 will be 550 mAh.

Because the modules 110 - 140 are connected in parallel, the nominal output voltage of the battery pack 100a is the same as the nominal output voltage of each module 110 -140, i.e. 4.8 v, and the capacity of the battery pack 100a is equal to the sum of the capacity of each of the modules 110 - 140, i.e. 4 × 550 mAh = 2200 mAh. Thus, connecting the cells in each module in series permits a desired nominal output voltage (4.8v in this example) to be achieved, whilst connecting the modules in parallel permits a desired nominal capacity (2200 mAh in this example) to be achieved.

As will be appreciated by those of ordinary skill in the art, many different permutations of series/parallel connections between cells and/or modules can be employed to achieve a desired nominal output voltage and capacity for a battery pack.

FIG. 1b is a simplified schematic representation of another example battery pack. As shown, the battery pack 100b in this example comprises two modules 170, 180 connected in parallel between positive and negative output terminals 150, 160. Each module 170, 180 in this example comprises four pairs 118a, 118b - 124a, 124b of parallel-connected cells, which are coupled in series.

By way of example, if each individual cell has a nominal capacity of 550 mAh and a nominal voltage of 1.2 v, the nominal output voltage of a pair 118a, 118b - 124a, 124b of cells is 1.2 v, and the nominal capacity of each pair 118a, 118b - 124a, 124b of cells is 1100 mAh. The nominal voltage of each module 170, 180 in the FIG. 1b example will be 4 × 1.2 v = 4.8 v, and the nominal capacity of each module 170, 180 will be 1100 mAh.

Because the modules 170, 180 are connected in parallel, the nominal output voltage of the battery pack 100b is the same as the nominal output voltage of each module 170, 180, i.e. 4.8 v, and the capacity of the battery pack 100b is equal to the sum of the capacity of each of the modules 170, 180, i.e. 2 × 1100 mAh = 2200 mAh. Thus, the example battery pack 110b illustrated in FIG. 1b is an alternative configuration of a battery pack that provides the same nominal voltage and capacity as the example battery pack 110a shown in FIG. 1a.

As will be appreciated by those of ordinary skill in the art, many applications will require a battery pack with a greater nominal output voltage and/or a greater nominal capacity than those of the example battery packs 110a, 110b shown in FIGS. 1a and 1b. For example, a battery pack for an electric vehicle may use two parallel-connected strings of cells, each string containing 96 series-connected cells each having a nominal voltage of 3.7 - 4 v, and each string having a nominal capacity of 55 Ah. The nominal output voltage of such a battery pack is of the order of 400 v, and the nominal capacity is of the order of 110 Ah.

FIGS. 2a - 2e show some examples of different series/parallel connections between cells that could be used in a module or a battery pack. FIG. 2a shows a single cell. FIG. 2b shows a single string 220 comprising two cells connected in series, in a configuration that may be denoted 2s1p. FIG. 2c shows two cells connected in parallel, in a configuration that may be denoted 1s2p. FIG. 2d shows two parallel-connected strings 240a, 240b, each containing three series-connected cells, in a configuration that may be denoted 3s2p. FIG. 2e shows three parallel-connected strings 250a - 250c, each containing two series-connected cells, in a configuration that may be denoted 2s3p. More generally, the notation XsYp indicates Y parallel-connected strings, each containing X series-connected cells. Thus, the battery pack 100a illustrated in FIG. 1a may be denoted 4s4p (or B4s4p, where B indicates that the arrangement is a battery pack), since it contains four parallel-connected strings each containing four series-connected cells. More generally, a battery pack comprising Y parallel strings each containing X series-connected cells may be denoted BXsYp, while a module comprising Y parallel strings each containing X series-connected cells may be denoted MXsYp.

### SUMMARY

According to a first aspect, the invention provides a battery pack comprising:

a set of N parallel-coupled switched cell strings, each switched cell string comprising a cell and a switch for selectively coupling a first terminal of the cell to a first terminal of the battery pack.

A second terminal of the cell of each switched cell string may be coupled to a second terminal of the battery pack.

Each cell string may comprise two or more cells connected in series.

The battery pack may further comprise a selectable shunt path coupled in parallel with the set of switched cell strings.

The selectable shunt path may comprise a resistive element coupled in series with a shunt control switch.

The battery pack may further comprise a control terminal for receiving one or more control signals to control operation of the switches.

N may be an integer equal to or greater than 2.

The battery pack may comprise a plurality of sets of N parallel-coupled switched cell strings, the sets of parallel-coupled switched cell strings being coupled in series between the first terminal of the cell and a second terminal of the cell.

The battery pack may further comprise control circuitry configured to control the switches of the cell strings to steer a charging current received by the battery pack to the cell of each of the cell strings according to one or more predetermined duty cycles.

The duty cycle may be variable based on a parameter of the battery.

The parameter of the battery may comprise one or more of:
a state of charge of a cell;
a terminal voltage of a cell; and/or
a total accumulated charging time of a cell over a plurality of charging cycles.

The control circuitry may be operable to control operation of the switches of the battery pack such that:
during a first phase of a charging cycle, a cell of a first cell string of the battery pack receives the charging current and a cell of a second cell string of the battery pack receives no charging current; and
during a second phase of the charging cycle, the cell of the second cell string receives the charging current and the cell of the first cell string receives no current.

The control circuitry may be operable to control operation of the switches such that over a plurality of charging cycles, an average duration of the first and second phases is constant, but the duration of individual first and second charging phases varies.

The control circuitry may be operable to cause the switches of the first and second cell string to be open and to cause the shunt control switch to be closed during a third phase, such that the charging current is steered through the resistive element during the third phase.

According to a second aspect the invention provides a charging device for charging a battery pack according to the first aspect, the charging device comprising:
a current source configured to output a charging current; and
control circuitry configured to control the switches of the cell strings to steer the charging current to the cell of each of the cell strings according to one or more predetermined duty cycles.

The duty cycle may be variable based on a parameter of the battery.

The parameter of the battery may comprise one or more of:
a state of charge of a cell;
a terminal voltage of a cell; and/or
a total accumulated charging time of a cell over a plurality of charging cycles.

The control circuitry may be operable to control operation of the switches of the battery pack such that:
during a first phase of a charging cycle, a cell of a first cell string of the battery pack receives the charging current and a cell of a second cell string of the battery pack receives no charging current; and
during a second phase of the charging cycle, the cell of the second cell string receives the charging current and the cell of the first cell string receives no current.

The control circuitry may be operable to control operation of the switches such that over a plurality of charging cycles, an average duration of the first and second phases is constant, but the duration of individual first and second charging phases varies.

The control circuitry may be operable to control operation of the switches of the battery pack such that:

during a third phase of the charging cycle, the cell of the first string and the cell of the second string receive no charging current.

The control circuitry may be operable to cause the current source to act as a current sink during the third phase so as to partially discharge the cells of the first and second cell strings through the current source during the third phase.

The charging device may further comprise a selectable shunt path, wherein, in use of the charging device, the selectable shunt path is coupled in parallel with the cell strings of the battery pack.

The selectable shunt path may comprise a resistive element coupled in series with a shunt control switch.

The control circuitry may be operable to cause the switches of the first and second cell string to be open and to cause the shunt control switch to be closed during the third phase, such that the charging current is steered through the resistive element during the third phase.

The control circuitry may be operable to cause the switches of the first and second cell string and the shunt control switch to be closed during the third phase, so as to partially discharge the cells of the first and second cell strings through the resistive element during the third phase.

According to a third aspect the invention provides a battery pack comprising:
a plurality of cell strings coupled in parallel with one another, each cell string comprising a cell; and
a switch network operable to selectively couple one of the plurality of cell strings to a terminal of the battery pack.

According to a fourth aspect the invention provides a battery pack comprising:
a plurality of cell strings coupled in parallel with one another; and
a switch network operable to selectively steer a charging current received at a terminal of the battery pack to one of the plurality of cell strings.

According to a fifth aspect the invention provides a battery pack comprising:

a switched cell string comprising a cell and a switch for selectively coupling a first terminal of the cell to a first terminal of the battery pack.

The battery pack may further comprise a series combination of a resistive element and a switch coupled in parallel with the switched cell string.

According to a sixth aspect the invention provides a cell string for a battery pack, the cell string comprising a series combination of at least one cell and a switch.

According to a seventh aspect the invention provides a charging device for charging a battery or a battery pack using a pulsed current charging scheme, wherein the device is configured to output a constant charging current over the during of a charging cycle period, wherein the charging cycle period comprises a charging phase and a relaxation interval.

According to an eighth aspect the invention provides an integrated circuit implementing a charging device according to the second aspect or the seventh aspect.

According to a ninth aspect the invention provides a method for pulsed-current charging of a battery or battery pack, the method comprising:
generating a constant charging current;
steering the constant charging current to a cell string of the battery or battery pack during a charging phase of a pulsed current charging cycle period; and
steering the constant charging current to a shunt path during a relaxation interval of the pulsed current charging cycle period.

According to a tenth aspect the invention provides a host device comprising a battery pack according to any of the first to fifth aspects.

The host device may comprise an electric vehicle, an electric bicycle, a wheelchair, an electric scooter, a cordless power tool, a computing device, a laptop, notebook or tablet computer, a portable battery powered device, a mobile telephone or an accessory device for such a host device.

### BRIEF DESCRIPTION OF THE DRAWINGS

Embodiments of the invention will now be described, strictly by way of example only, with reference to the accompanying drawings, of which:

FIG. 1a is a simplified schematic representation of an example battery pack;

FIG. 1b is a simplified schematic representation of an alternative example battery pack;

FIGS. 2a - 2e show examples of different series/parallel connections between cells that could be used in a battery pack or a module of a battery pack;

FIG. 3 is a schematic illustration of a constant current, constant voltage (CC-CV) arrangement for charging batteries or battery packs;

FIG. 4 illustrates a pulsed current charging arrangement;

FIG. 5 is a schematic diagram illustrating a system for charging a battery pack according to the present disclosure;

FIG. 6 illustrates charging current waveforms used in the system of FIG. 5;

FIG. 7a is a schematic diagram illustrating a first alternative system for charging a battery pack according to the present disclosure;

FIG. 7b is a schematic diagram illustrating a second alternative system for charging a battery pack according to the present disclosure

FIG. 8 illustrates charging current waveforms used in the system of FIGS. 7a and 7b;

FIG. 9 is a schematic diagram illustrating a system for charging an alternative battery pack according to the present disclosure;

### DETAILED DESCRIPTION

One barrier to the adoption of electric vehicles (EVs) is the length of time it takes to charge the vehicle’s battery pack. A standard 7 kW charger of the kind that can be installed in homes, workplaces and other public locations typically takes around ten hours to charge an EV battery pack from its discharged state to its fully charged state. More powerful 150 kW chargers of the kind provided by certain suppliers typically take around 40 minutes to charge an EV battery pack to 80% of its maximum capacity. There is thus considerable interest in developing faster charging schemes for EV battery packs.

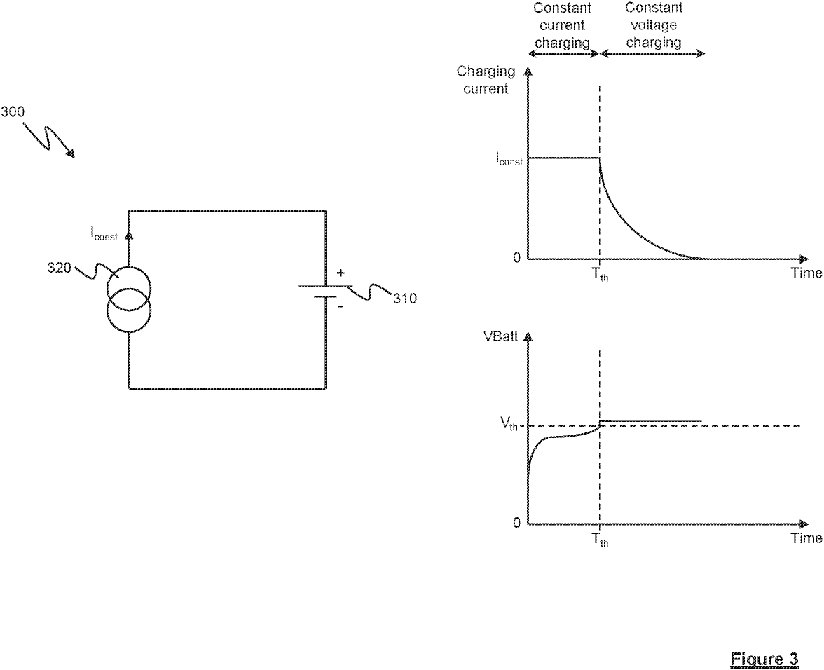

FIG. 3 is a schematic illustration of one arrangement for charging batteries or battery packs. In the illustrated arrangement, which is known as constant current, constant voltage (CC-CV), the battery or battery pack (represented in FIG. 3 by battery 310) is charged with a constant charging current I_{const} (provided in FIG. 3 by current source 320) until a voltage VBatt across the terminals of the battery 310 (referred to as the terminal voltage of the battery 310) reaches a predefined level Vₜₕ (at a time Tₜₕ), which may be, for example, 80% of a nominal maximum terminal voltage Vₘₐₓ. Once the terminal voltage has reached the predefined level Vₜₕ, a constant charging voltage is applied to the battery 310 while the charging current decreases over time until the nominal maximum terminal voltage of the battery 310 is achieved. This method is safe and widely used, but is also slow.

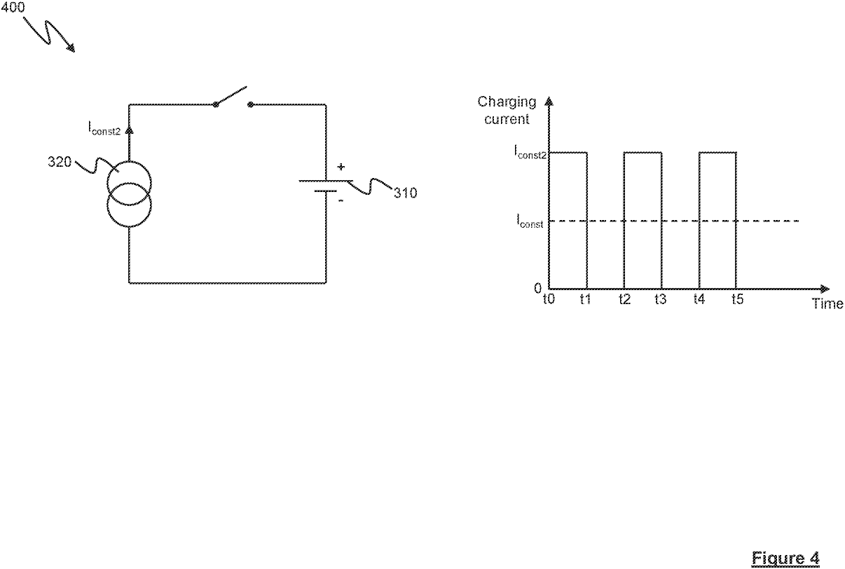

FIG. 4 illustrates an alternative charging arrangement, known as pulsed current charging. In this arrangement, a constant current I_{const2} (which in the illustrated example is higher than the constant current I_{const} used in the arrangement of FIG. 3) is applied to the battery 310 with a duty cycle, such that during a first period (t0 - t1) of the duty cycle a current I_{const2} is applied to the battery 310, and during a second period (t1 - t2) of the duty cycle no current is applied to the battery. If, for example, the current I_{const2} is twice the current I_{const} and the first and second periods (t0 - t1 and t1 - t2) are of equal length, then the peak current that is applied to the battery 310 during the first period (t0 - t1) illustrated in FIG. 4 is twice the peak current applied in an equivalent period in the arrangement of FIG. 3, but the average current applied to the battery 310 over a single cycle (t0 - t2) of the pulsed current charging method is the same as the average current applied to the battery 310 in an equivalent period of time in the CC-CV arrangement of FIG. 3.

The pulsed current approach of FIG. 4 may reduce the time required to charge the battery 310, but requires an increased peak current in order to achieve the same average charging current over a given period of time as the approach illustrated in FIG. 3. In some applications, however, it may be difficult to implement a pulsed current charging scheme due to the requirement for a higher peak current than a CC-CV scheme. For example, for charging an electric vehicle battery, increasing the peak current gives rise to increased thermal effects in the charger and/or the battery, and to significant challenges for the grid supplying the charger.

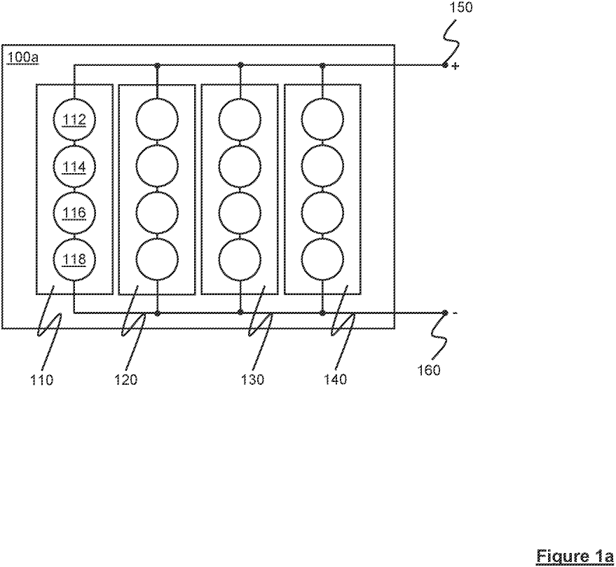

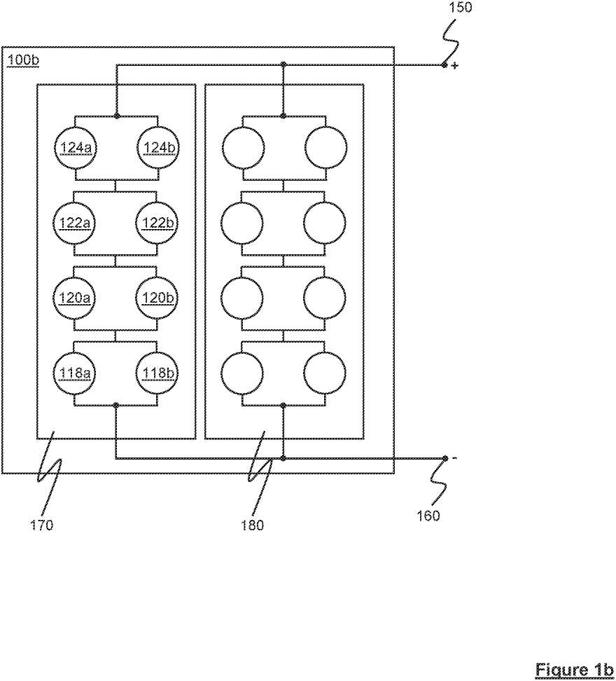

As discussed above with reference to FIG. 1b, some battery packs (e.g. battery packs for electric vehicles) comprise one or more modules that each include one or more pairs of parallel-connected cells. This parallel arrangement of the cells permits the use of a pulsed current charging scheme without increasing peak charging current, as will now be explained.

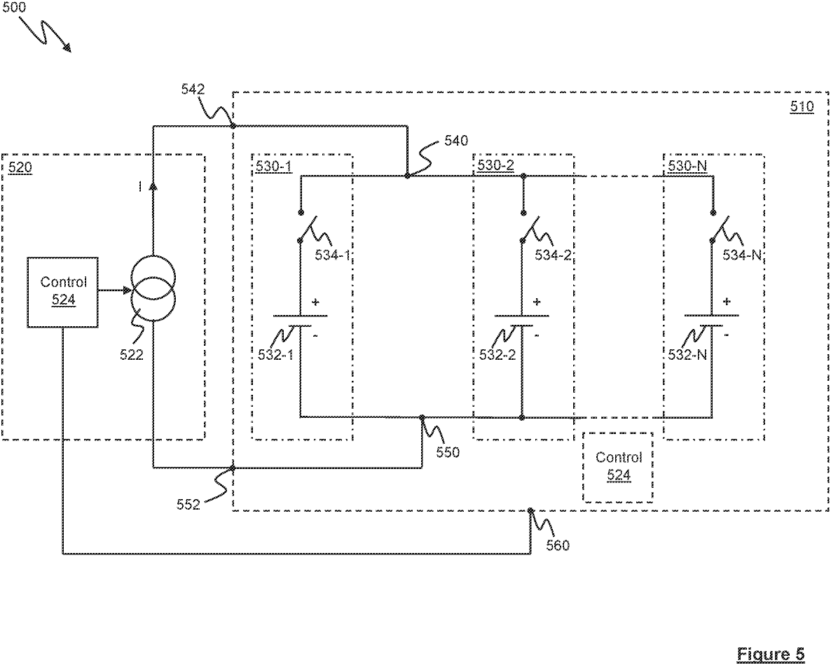

FIG. 5 is a schematic diagram illustrating a system for charging a battery pack according to the present disclosure.

The system, shown generally at 500 in FIG. 5, includes a battery pack 510 and charging circuitry 520.

The battery pack 510 includes a set of N switched cell strings 530-1 - 530-N (where N is an integer greater than 2) coupled in parallel between a first node 540 and a second node 550. The first node 540 is in turn coupled to a first terminal 542 of the battery pack 510, and the second node 550 is coupled to a second terminal 552 of the battery pack 510.

Each of the cell strings 530-1 - 530-N includes a respective set of one or more cells 532-1 - 532-N coupled in series with a respective switch 534-1 - 534-N, which is operable to selectively couple the set of one or more cells of its cell string to the first node 540 of the battery pack. Thus the switches 534-1 - 534-N constitute a switch network which is operable to selectively couple one (or more) of the cells to the first terminal 542 of the battery pack 510.

In the example illustrated in FIG. 5, a first cell string 530-1 includes a first cell 532-1 having a negative terminal coupled to the second node 550 of the battery pack and a positive terminal coupled to a first terminal of a first switch 534-1. A second terminal of the first switch 534-1 is coupled to the first node 540 of the battery pack 510. The first switch 534-1 is thus operable to selectively couple the positive terminal of the first cell 532-1 to the first terminal 542 of the battery pack 510.

Similarly, a second cell string 530-2 includes a second cell 532-2 having a negative terminal coupled to the second node 550 of the battery pack and a positive terminal coupled to a first terminal of a second switch 534-2. A second terminal of the second switch 534-2 is coupled to the first node 540 of the battery pack 510. The second switch 534-2 is thus operable to selectively couple the positive terminal of the second cell 532-2 to the first terminal 542 of the battery pack 510.

An Nth cell string 530-N includes an Nth cell 532-N having a negative terminal coupled to the second node 550 of the battery pack and a positive terminal coupled to a first terminal of an Nth switch 534-N. A second terminal of the Nth switch 534-N is coupled to the first node 540 of the battery pack 510. The Nth switch 534-N is thus operable to selectively couple the positive terminal of the Nth cell 532-N to the first terminal 542 of the battery pack 510.

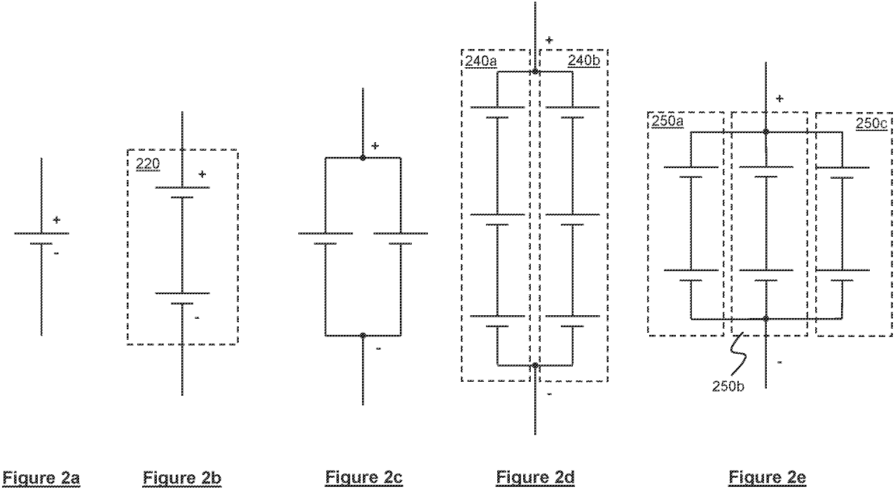

Although in the example illustrated in FIG. 5 each cell string 530-1 - 530-N is shown as including a single cell 532-1 - 532-N, it is to be appreciated that each cell string 530-1 - 530-N could instead include two or more cells coupled in series (as shown, for example, in FIG. 2b), two or more cells coupled in parallel (as shown, for example, in FIG. 2c), or a combination of series and parallel coupled cells (as shown, for example, in FIGS. 2d and 2e) in place of the single cell shown in FIG. 5. For simplicity, it is to be understood that the term “cell” used herein may refer either a single cell or to a plurality of cells coupled in series and/or in parallel.

The charging circuitry 520 (which may also be referred to as a charging device) includes a current source 522 configured to supply a constant charging current I to the battery pack 510 and control circuitry 524 configured to, in use of the system 500, control operation of the switches 534-1 - 534-N of the cell strings 530-1 - 530-N so as to selectively provide or steer the charging current to the cells 532-1 - 532-N. In some examples the control circuitry 524 may also control operation of the current source 522.

In use of the system 500, the current source 522 is coupled to the first and second terminals 542, 552 of the battery pack 510 so as to provide the charging current I to the battery pack 510, and the control circuitry 524 is coupled to a control input terminal 560 of the battery pack 510 to provide appropriate control signals to control operation of the switches 534-1 - 534-N.

The control circuitry 524 may control the operation of the switches 534-1 - 534-N according to one or more predetermined duty cycles, to selectively supply or steer current to one (or more) of the cells 532-1 - 532-N.

For example, if the battery pack 510 included only first and second cell strings 530-1, 530-2, then the control circuitry 524 may be operable to control the switches 534-1, 534-2 such that during a first phase P1 of a charging cycle the charging current I is supplied to the first cell 532-1 belonging to the first cell string 530-1, and during a second phase P2 of the charging cycle the charging current I is supplied to the second cell 532-2 belonging to the second cell string 530-1.

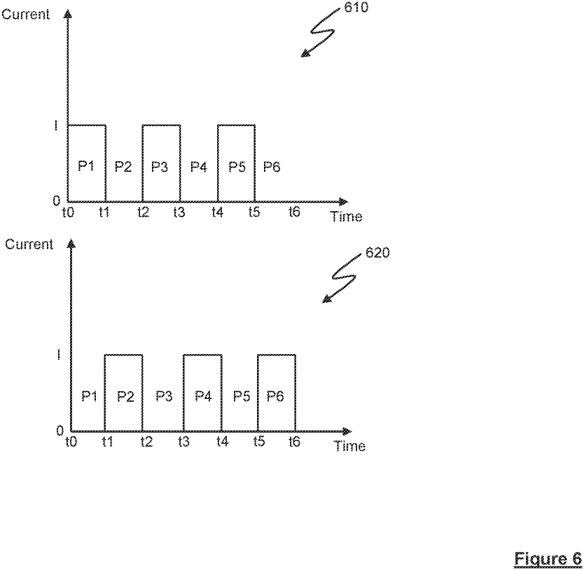

This approach is illustrated in FIG. 6. The upper graph 610 of FIG. 6 shows current supplied to the first cell 532-1 during a plurality of charging cycles. The lower graph 620 shows current supplied to the second cell 532-2 during the plurality of charging cycles. In the example illustrated in FIG. 6, during the first phase P1 (which lasts from time t = t0 to time t = t1) of a first charging cycle (which lasts from time t = t0 to time t = t2), the first switch 534-1 is closed and the second switch 534-2 is open (in response to appropriate control signals issued by the control circuitry 524), such that all of the charging current I is supplied to the first cell 532-1, and the second cell 532-2 receives no current. During the second phase P2 (which lasts from time t=t1 to time t=t2) of the first charging cycle, the first switch 534-1 is open and the second switch 534-2 is closed (in response to appropriate control signals issued by the control circuitry 524), such that all of the charging current I is supplied to the second cell 532-2, and the first cell 532-1 receives no current. Similarly, during a first phase P3 (which lasts from time t = t2 to time t = t3) of a second charging cycle (which lasts from time t = t2 to time t = t4), the first switch 534-1 is again closed and the second switch 534-2 is again open (in response to appropriate control signals issued by the control circuitry 524), such that all of the charging current I is supplied to the first cell 532-1, and the second cell 532-2 receives no current. During the second phase P4 (which lasts from time t = t3 to time t = t4) of the second charging cycle, the first switch 534-1 is again open and the second switch 534-2 is again closed (in response to appropriate control signals issued by the control circuitry 524), such that all of the charging current I is supplied to the second cell 532-2, and the first cell 532-1 receives no current.

Thus, the approach illustrated in FIG. 6a achieves pulsed current charging of the first and second cells 532-1, 532-2, since each cell 532-1, 532-2 receives the full charging current for only part of every charging cycle period.

If the charging current I were supplied in a conventional CC-CV charging system of the kind illustrated in FIG. 3, the charging current I would be divided between the first and second cells 532-1, 532-2 for the whole of each charging period t0 - t2, t2 - t4 (until the terminal voltage of the battery pack 510 reached a threshold voltage). Assuming that the first and second cells 532-1, 532-2 have the same impedance, a charging current of I/2 would be supplied to each cell during each charging period.

In contrast, in the approach described above with reference to FIGS. 5 and 6, the first and second cells 532-1, 532-2 each receive the full charging current I for a respective phase P1, P2 of a charging cycle period. Thus, compared to a conventional CC-CV charging system that supplies a constant charging current I to two parallel-connected cells having the same impedance (such that each cell receives a current of I/2 for the full duration of the charging cycle period), in the approach described above with reference to FIGS. 5 and 6, the first and second cells 532-1, 532-2 each receive twice the current (i.e. each cell receives the full current I) for their respective phases P1, P2 of the charging cycle period.

The phase of the charging cycle period in which the cell 532-1, 532-2 does not receive any charging current provides a relaxation interval for that cell. For example, during the second phase P2 of the first charging cycle period t0 - t2, the first cell 532-1 does not receive any charging current, and thus the second phase P2 provides a relaxation interval for the first cell 532-1. Similarly, during the first phase P3 of the second charging cycle period t2 - t4, the second cell does not receive any charging current, and thus the first phase P3 of the second charging cycle period provides a relaxation interval for the second cell 532-2.

These relaxation intervals may help to reduce the total time required to charge the cells to their full capacity, or to a given proportion of their full capacity. For example, where the cells 532-1, 532-2 are lithium-ion cells, providing a relaxation interval for the cells may help to prevent or restrict the formation of metallic lithium within the cell, thus reducing the overall charging time of the cell.

In the approach illustrated in FIG. 6, the control circuitry 524 is operative to close the switch 534-2 of the second cell string 530-2 and to open the switch 534-1 of the first cell string 530-1 simultaneously so as to begin the second charging phase P2 as soon as the first charging phase P1 has ended, and to open the switch 534-2 of the second cell string 530-2 and to close the switch 534-1 of the first cell string 530-1 simultaneously so as to begin a subsequent first charging phase P1 as soon as the second charging phase P2 has ended, such that there is no overlap between the first and second charging phases P1, P2.

As will be appreciated, in a practical implementation of the system 500, precisely synchronising the operation of the switches 534-1, 534-2 in this way may be challenging. Thus, in an alternative approach the control circuitry 524 may be operative to permit a limited degree of overlap between the first and second charging phases P1, P2, by closing the switch 534-2 of the second cell string 530-2 before opening the switch 534-1 of the first cell string 530-1 to begin the second charging phase P2, and by closing the switch 534-1 of the first cell string 530-1 before opening the switch 534-1 of the first cell string 530-1 to begin a subsequent first charging phase P1. As will be appreciated, during the periods of overlap between the first and second charging periods, the respective cells 532-1, 532-2 of the first and second cell strings 530-1 , 530-2 will each receive a charging current that that is less than the full charging current I (e.g. ½, if the impedances the first and second cell strings 530-1, 530-2 are equal), but when the period of overlap has ended, only one of the cells receives the full charging current l.

Thus, for the majority of the first charging phase, the cell 532-1 of the first cell string 530-1 will receive the full charging current l.During a short period (relative to the total period of the first charging phase P1) of overlap between the first and second charging phases P1, P2, the cells 532-1, 532-2 of the respective first and second cell strings 530-1, 530-2 each receive a proportion of the charging current I based on (e.g. inversely proportional to) its respective impedance. For the remainder of the second charging phase P2, the cell 532-2 of the second cell string 530-2 receives the full charging current l.During a short period (relative to the total period of the first charging phase P2) of overlap between the second charging phase P2 and a subsequent first charging phase, the cells 532-1, 532-2 of the respective first and second cell strings 530-1, 530-2 again each receive a proportion of the charging current I based on (e.g. inversely proportional to) its respective impedance.

By permitting a degree of overlap between the first and second charging phases P1, P2 in this way, the current source 522 is able to operate continuously to output the constant charging current l.

In the example illustrated in FIG. 6, the control circuitry 524 implements a duty cycle in which the phases P1 and P2 are of equal duration - i.e. a duty cycle of 50% - such that the first and second cells 532-1 , 532-2 each receive the charging current I for 50% of the charging cycle period. However, in other examples the control circuitry 524 may implement duty cycle in which the phases P1 and P2 are not of equal duration, such that the proportion of the charging cycle period for which the first cell 532-1 receives the charging current I is different from the proportion of the charging cycle period for which the second cell 532-2 receives the charging current l.

Further, the control circuitry 524 may be operative to adjust the duty cycle (by adjusting the durations of the phases P1 and P2) dynamically. For example, the control circuitry may be operative to adjust the duty cycle dynamically based on a parameter of the battery such as, for example, a state of charge (SoC) or terminal voltage of each of the cells 531-1, 531-2, and/or based on a total accumulated charging time of each cell over a plurality of charging cycles.

For example, if the first cell 532-1 has a lower terminal voltage or SoC than the second cell 532-1 , the control circuitry 524 may be operative to increase the duration of the phase P1 and reduce the duration of the phase P2, such that the first cell 532-1 receives the charging current I for a longer duration than the second cell 532-2 in each charging cycle period, until such time as the SoC and/or terminal voltages of the first and second cells have equalised (or are within an acceptable threshold amount of each other).

Thus, the control circuitry 524 may include monitoring circuitry (not illustrated) for monitoring a parameter of the battery such as, for example, the terminal voltage and/or SoC of each of the cells 532-1 - 532-N of the battery pack 510, and may be configured to dynamically adjust the duty cycle of operation of the switches 534-1 - 534-N based on the monitored parameter. The monitoring circuitry may monitor the parameter continuously or periodically, e.g. once per charging cycle period, every other charging cycle period, every tenth charging cycle period etc.

Additionally or alternatively, the control circuitry 524 may include timer circuitry for estimating or determining the total accumulated charging time of each cell over a plurality of charging cycles, and may be configured to dynamically adjust the duty cycle of operation of the switches 534-1 - 534-N based on the total accumulated charging time of each cell, e.g. to progressively reduce the proportion of each charging cycle for which a cell receives the charging current as the total accumulated charging time increases.

The periodic nature of the switching of the switches 534-1, 534-2 to control the charging phases as described above may lead to radiated electromagnetic interference (EMI), or possibly even audible tones generated by non-ideal components in the system 500. To mitigate these issues, it may be beneficial to implement a spread spectrum approach to controlling the charging phases P1, P2 or the generation of the charging pulses, such that over a plurality of charging cycles the average duration of the charging pulses is constant, but the duration of individual charging pulses varies around a nominal value. This may be achieved, for example, by pseudo-randomly modulating the frequency of the switching of current source 522 (e.g. by the control circuitry 524), such that the switching is not periodic (i.e. the switching frequency is not constant), but instead the switching frequency changes on a pseudo-random basis. An effect of pseudo-randomly modulating the switching frequency in this way is to spread the EMI over a broader frequency range or bandwidth, because there is no single constant switching frequency that could lead to a peak of EMI at the switching frequency, but instead a greater number of smaller peaks at multiple different frequencies. If a spread-spectrum approach to controlling the charging phases is implemented, the characteristics (e.g. frequency, bandwidth and/or amplitude) of any resulting EMI are similar to those of broadband noise, and thus the EMI can be mitigated (e.g. rejected or suppressed) more easily by affected components, systems and the like.

In the example described above with respect to FIG. 6, the battery pack includes only two parallel cell strings. It will be appreciated, however, that the principles described above are equally applicable to systems for charging battery packs having any number of parallel cell strings. In general, for a battery pack having N parallel cell strings that each contain a cell and an associated switch, the charging cycle period may comprise N phases, which may be of equal duration (i.e. P1 = P2 = ... PN = T/N, where T is the duration of the charging cycle period), or may be of unequal duration, or whose duration may be dynamically adjustable based on, for example, a parameter of the battery pack, e.g. a terminal voltage, SoC or total accumulated charging time of each of the N cells.

In some circumstances it may be beneficial if a charging cycle period includes a phase in which none of the cells of the battery pack 510 is supplied with a charging current, for example to allow the cells increased relaxation intervals between periods of charging at a relatively high charging current. It may also be beneficial in some circumstances occasionally, intermittently or periodically to include a discharge period in the charging cycle period, during which the cells can partially discharge.

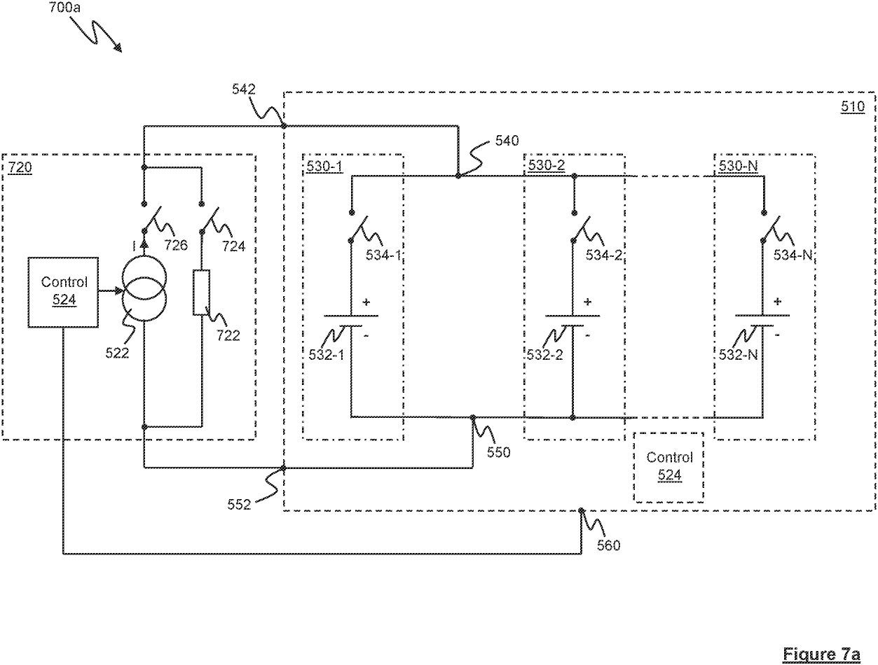

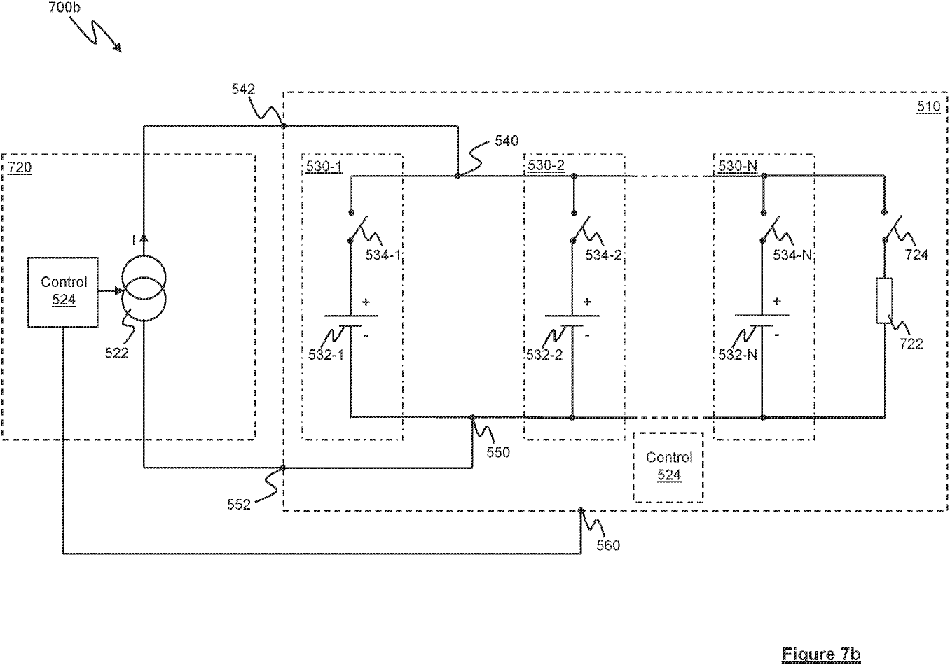

FIG. 7a is a schematic diagram illustrating a system for charging a battery pack according to the present disclosure. The system, shown generally at 700a in FIG. 7, includes a number of elements in common with the system 500 described above with reference to FIG. 5. Such common elements are denoted by common reference numerals and will not be described in detail here, for the sake of clarity and brevity.

Like the system 500, the system 700a includes charging circuitry (here denoted by the reference numeral 720) that includes a current source 522 and control circuitry 524. The charging circuitry 720 (which may also be referred to as a charging device) also includes a selectable shunt path comprising an active or passive resistive element 722, such as a current sink (active) or a resistor (passive), coupled in series with a shunt control switch 724, and the series combination of the resistive element 722 and the shunt control switch 724 is coupled in parallel with the current source 522. In some examples the charging circuitry 720 may further include a current control switch 726 coupled in series with the current source 522. In an alternative example system, shown generally at 700b in FIG. 7b, the selectable shunt path comprising the series combination of the resistive element 722 and the shunt control switch 724 is coupled in parallel with the cell strings 530-1 -530-N within the battery pack 510.

In use of the system 700a (or the alternative system 700b), the current source 522 is coupled to the first and second terminals 542, 552 of the battery pack 510 so as to provide the charging current I to the battery pack 510 when the current control switch 726 (if provided) is closed.

The control circuitry 524 controls the operation of the switches 534-1 - 534-N and the shunt control switch 724 according to a predetermined duty cycle, to selectively supply or steer current to one (or more) of the cells 532-1 - 532-N and to the resistive element 722.

For example, if the battery pack 510 included only first and second cell strings 530-1, 530-2, then the control circuitry 524 may be operable to control the switches 534-1, 534-2 such that during a first phase P1 of a charging cycle the charging current I is supplied to the first cell 532-1 belonging to the first cell string 530-1, during a second portion P2 of the charging cycle the charging current I is supplied to the second cell 532-2 belonging to the second cell string 530-1, and during a third phase P3 of the charging cycle the current is provided to the resistive element 722.

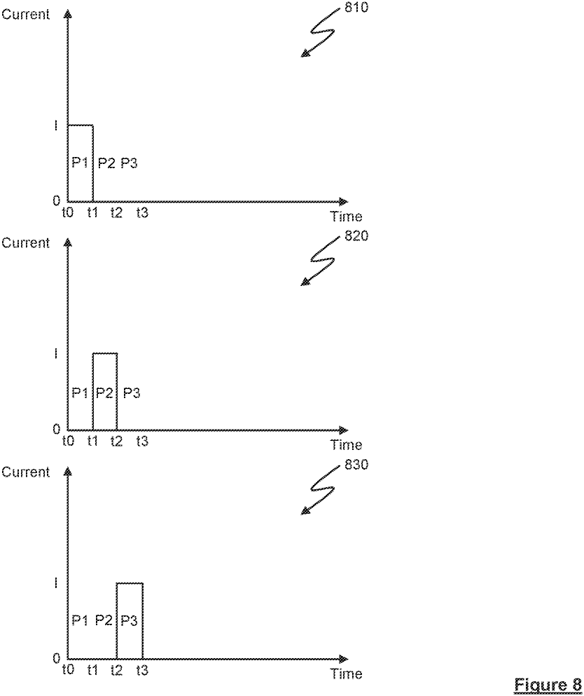

This approach is illustrated in FIG. 8, in which the upper graph 810 shows current supplied to the first cell 532-1 over a charging cycle, the central graph 820 shows current supplied to the second cell 532-2 over the charging cycle, and the lower graph 830 shows current supplied to the resistive element 722 over the charging cycle. In the example illustrated in FIG. 8, during the first phase P1 of the charging cycle (which lasts from time t = t0 to time t = t1), the first switch 534-1 is closed and the second switch 534-2 and the shunt control switch 724 are open (in response to appropriate control signals issued by the control circuitry 524), such that all of the charging current l is supplied to the first cell 532-1, and the second cell 532-2 and the resistive element 722 receive no current. During the second phase P2 of the charging cycle (which lasts from time t = t1 to time t = t2), the first switch 534-1 and the shunt control switch 724 are open and the second switch 534-2 is closed (in response to appropriate control signals issued by the control circuitry 524), such that all of the charging current l is supplied to the second cell 532-2, and the first cell 532-1 and the resistive element 722 receive no current. During the third phase P3 of the charging cycle (which lasts from time t = t2 to time t = t3), the first switch 534-1 and the second switch 534-2 are open and the shunt control switch 724 is closed (in response to appropriate control signals issued by the control circuitry 524), such that all of the charging current l is supplied to the resistive element 722 and the first cell 532-1 and the second cell 532-2 receive no current.

Thus the approach illustrated in FIG. 8 achieves pulse current charging of the cells 532-1, 532-2, since each cell 532-1, 532-2 receives the full charging current for only a phase of each charging cycle period. The third phase P3 provides an extended relaxation interval between charging periods of the cells 532-1, 532-2, which may further help to reduce the total time required to charge the cells to their full capacity, or to a given proportion of their full capacity. For example, where the cells 532-1, 532-2 are lithium-ion cells, providing an extended relaxation interval for the cells may further help to prevent or restrict the formation of metallic lithium within the cell, thus reducing the overall charging time of the cell.

By shunting current to ground via the resistive element 722 during the third phase P3, the current source 522 can remain operational to output a constant charging current for the whole charging cycle, rather than being deactivated or disconnected during the third phase P3. This reduces the risk of transients when the current source 522 is disconnected from and reconnected to the battery pack, and maintains the current I at a constant level, such that there is no delay while the current I increases to a desired level when current source 522 is reactivated after being deactivated for the third phase.

In the example described above with reference to FIGS. 7 and 8, there is no overlap between the first, second and third charging phases P1, P2, P3. However, as in the example discussed above with reference to FIGS. 5 and 6, the control circuitry 524 may be operative to permit a limited degree of overlap between the first, second and third charging phases P1, P2, P3, by allowing short periods in which two of the switches 534-1, 534-2, 724 to be closed at the same time, instead of precisely synchronising the opening of one of the switches 534-1, 534-2, 724 with the opening of another of the switches 534-2, 724, 534-1. As in the exampled described above with reference to FIGS. 5 and 6, by permitting overlap between the charging phases P1 - P3 in this way the current source 522 is able to operate continuously to output the constant charging current l.

Again, a spread spectrum approach to controlling the switching of the switches 534-1, 534-2, 724 may be implemented to mitigate EMI issues that may otherwise arise as a result of periodic switching.

In the example described above with respect to FIG. 8, the battery pack includes only two parallel cell strings. It will be appreciated, however, that the principles described above are equally applicable to systems for charging battery packs having any number of parallel cell strings.

In particular, the principle of providing a relaxation interval during pulsed-current charging while also maintaining a constant charging current output from a current source, by shunting current away from a cell string, e.g. through a parallel connected active or passive resistive element, is applicable to batteries or battery packs that have only a single switched cell string (e.g. cell string 530-1). By providing a selectable shunt current path comprising a series combination of a resistive element 722 and a shunt control switch 724 that can be coupled in parallel with the single switched cell string, either within the battery or battery pack (in a similar manner as illustrated in FIG. 7b) or as part of the charging circuitry 720 (as shown in FIG. 7a), a relaxation interval can be provided by closing the shunt control switch 724 and opening the switch of the cell string (in response to appropriate control signals from the control circuitry 524), such that current from the current source 522 is steered away from the cell(s) of the cell string into the shunt current path. In this way, a relaxation interval can be implemented for pulsed current charging of a battery or battery pack comprising a single cell string, while also maintaining a constant output current from the current source 522, thus reducing the risk of transients and delay in reaching a desired charging current l, as discussed above.

Moreover, the charging cycle (whether for a plurality of cell strings or for a single cell string) need not always include a phase where the charging current is shunted to ground via the resistive element 722. Instead, such shunting of the current may occur periodically (e.g. every second, fourth or tenth cycle), occasionally, or intermittently.

Further, although in the example illustrated in FIG. 7a the resistive element 722 and the shunt control switch 724 are provided as part of the charging circuitry 720, in other examples the resistive element 722 and the shunt control switch 724 may be provided as part of the battery pack 510, e.g. coupled in parallel with the cell strings 530-1 - 530-N of the battery pack 510, as shown in FIG. 7b.

Providing a third phase P3 in which none of the cells 532-1, 532-2 receives a charging current also permits selective discharging of the cells 532-1 , 532-2 during the third phase P3.

If partial discharging of the cells is required as part of the charging cycle (either regularly - e.g. every cycle, periodically - e.g. every second, fourth or tenth cycle, occasionally or intermittently), the current control switch 726 can be opened and the shunt control switch 722 and switches 534-1, 534-2 can be closed (in response to appropriate control signals from the control circuitry 524) for a desired discharge period. During this discharge period, current flows from the cells 532-1 , 532-2 to ground, via the resistive element 722, thus partially discharging the cells 532-1, 532-2.

Alternatively, if partial discharging of the cells is required, the control circuitry 524 may issue a control signal to the current source 522 to cause it to act as a current sink, thus causing current to flow from the cells 532-1 , 532-2 to the current source, thereby partially discharging the cells 532-1, 532-2. In this case the current control switch 726 need not be provided, or if provided may remain closed. Similarly, the shunt control switch 724 and the resistor may be omitted, or if provided the shunt control switch 724 may remain open during the discharge period.

As before, although the concept of selectively discharging the cells of a battery pack regularly, periodically, occasionally or intermittently has been described above in the context of an example battery pack that includes only two parallel cell strings, it will be appreciated that the principles described above are equally applicable to systems for charging battery packs having any number of parallel cell strings.

In the examples described above, the battery pack 510 includes a plurality of switched cell strings connected in parallel between the first node 540 and the second node 550, but it will be appreciated that the principles of the present disclosure are equally applicable to other arrangements of cells within a battery pack, e.g. series and/or parallel combinations of cells of the kind illustrated in FIGS. 2b - 2e.

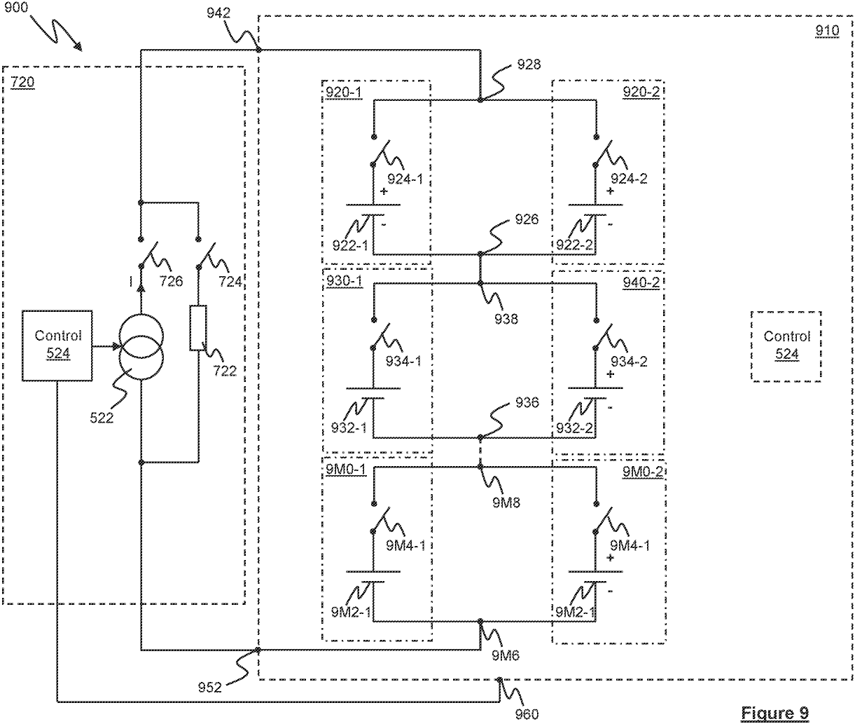

FIG. 9 is a schematic diagram illustrating a system for charging a battery pack according to the present disclosure. The system, shown generally at 900 in FIG. 9, includes a number of elements in common with the systems 700a, 700b described above with reference to FIGS. 7a and 7b. Such common elements are denoted by common reference numerals and will not be described in detail here, for the sake of clarity and brevity.

In the example shown in FIG. 9, a battery pack 910 comprises a plurality of pairs of parallel-coupled switched cell strings.

A first pair of parallel-coupled switched cell strings comprises a first switched cell string 932-1 and a second switched cell string 920-2 coupled in parallel with each other between a first node 926 and a second node 928. The second node 928 is coupled to a first terminal 942 of the battery pack 910. The first switched cell string 920-1 comprises a cell (or set of series-connected cells) 922-1 coupled in series with a switch 924-1. Similarly, the second switched cell string 920-2 comprises a cell (or set of series-connected cells) 922-2 coupled in series with a switch 924-2.

A second pair of parallel-coupled switched cell strings comprises a first switched cell string 930-1 and a second switched cell string 930-2 coupled in parallel with each other between a first node 936 and a second node 938. The second node 938 is coupled to the first node 926 of the first pair of parallel-coupled cell strings. The first switched cell string 930-1 comprises a cell (or set of series-connected cells) 932-1 coupled in series with a switch 934-1. Similarly, the second switched cell string 930-2 comprises a cell (or set of series-connected cells) 932-2 coupled in series with a switch 934-2.

An Mth pair of parallel-coupled switched cell strings comprises a first switched cell string 9M0-1 and a second switched cell string 930-2 coupled in parallel with each other between a first node 9M6 and a second node 9M8. The first node 9M6 is coupled to a second terminal 952 of the battery pack 910, and the second node 9M8 is coupled to the first node of an M-1th pair of parallel-coupled cell strings. The first switched cell string 9M0-1 comprises a cell (or set of series-connected cells) 9M2-1 coupled in series with a switch 9M4-1. Similarly, the second switched cell string 9M0-2 comprises a cell (or set of series-connected cells) 9M2-2 coupled in series with a switch 9M4-2.

Although in the example illustrated in FIG. 9 each cell string 920-1 - 9M0-2 is shown as including a single cell 922-1 - 9M2-2, it is to be appreciated that each cell string 920-1 - 9M0-2 could instead include two or more cells coupled in series in place of the single cell shown in FIG. 9. For simplicity, it is to be understood that the term “cell” used herein may refer either a single cell or to a plurality of cells coupled in series and/or parallel (e.g. in a configuration of the kind illustrated in FIGS. 2b - 2e).

The example system 900 includes charging circuitry 720 of the kind described above with reference to FIG. 7a, including a series combination of a shunt control switch 724 and an active or passive resistive element 722 coupled in parallel with the current source 522, and a current control switch 726 coupled in series with the current source 522. It will be appreciated, however, that the series combination of the shunt control switch 724 and the active or passive resistive element 722 could instead be provided in the battery pack 910, coupled in parallel with series combination of the M pairs of switched cell strings 920-1 - 9M0-2. For example, the series combination of the shunt control switch 724 and the resistive element 722 could be coupled to the nodes 928, 9M6.

In use of the system 900, the current source 522 is coupled to the first and second terminals 942, 952 of the battery pack 910 so as to provide the charging current I to the battery pack 910, and the control circuitry 524 is coupled to a control input terminal 960 of the battery pack 910 to provide appropriate control signals to control operation of the switches 924-1 - 9M4-2.

The control circuitry 524 controls the operation of the switches 924-1 - 9M4-2 according to one or more predetermined duty cycles, to selectively supply or steer current to one (or more) of the cells 922-1 - 9M2-2. The operation of the switches in each side of the plurality of pairs of parallel-coupled cell strings is synchronised, such that when the switches are closed the charging current is supplied to all of the cells in that side. Thus, in use of the system the control circuitry 524 outputs control signals to cause the switches 924-1 - 9M4-1 of the left-hand strings 920-1 - 9M0-1 to be opened or closed simultaneously, and the switches 924-2 - 9M4-2 of the right-hand strings 920-2 - 9M0-2 to be opened or closed simultaneously.

Thus, the control circuitry 524 may be operable to cause the switches 924-1 - 9M4-1 to be closed and the switches 924-2 - 9M4-2 to be open during a first phase P1 of a charging cycle, such that the charging current l is supplied to the cells 922-1 - 9M2-1 belonging to the first cell strings 920-1 - 92M0-1, and to cause the switches 924-2 -9M4-2 to be closed and the switches 924-1 - 9M4-1 to be open during a second phase P2 of the charging cycle, such that the charging current l is supplied to the cells 922-2 -9M2-2 belonging to the second cell strings 920-2 - 9M0-2.

In this way, pulsed current charging of the cells 922-1 - 9M2-2 can be achieved without requiring an increased charging current, since each cell 922-1, 9M2-2 receives the full charging current for only part of a charging cycle period.

As in the arrangement described above with reference to FIGS. 7 and 7b, a third phase P3 may be provided regularly (e.g. every charging phase), periodically (e.g. every second, fourth, tenth etc. charging phase), occasionally or intermittently, to provide an extended relaxation interval between charging periods of the cells 922-1 - 92M2-2, or to provide for a discharge period during which the cells 922-1 - 92M2-2 can be partially discharged.

Although the duration of the third phase P3 is shown in FIG. 8 as being approximately equal to that of the first and second phases P1, P2, it is to be understood that the third phase P3 may be of any suitable duration, which may be greater than, less than or equal to the duration of the first and/or second phase P1, P2.

To provide an extended relaxation interval during the third phase, the control circuitry 524 causes all of the switches 924-1 - 9M4-2 to be open, such that none of the cells 922-1 - 922-M receives a charging current. The control circuitry 524 further causes the shunt control switch 724 to be closed during the third phase, such that current is shunted to ground through the resistive element 722.

To provide a discharge period during the third phase P3, the control circuitry 524 causes all of the switches 924-1 - 9M4-2 to be closed. The control circuitry 524 may cause the current control switch 726 to be opened, to decouple the current source 522 from the cells 922-1 - 922-M, and may cause the shunt control switch 724 to be closed, to couple the cells 922-1 - 922-M to the resistive element 722, thereby partially discharging the cells 922-1 - 922-M through the resistive element 722.

Alternatively, the control circuitry 524 may cause the current control switch 726 to be closed, to couple the current source 522 to the cells 922-1 - 922-M, and may cause the current source 522 to act as a current sink, so as to partially discharge the cells 922-1 - 922-M by sinking current from them. In this case the shunt control resistive element 722 (if provided) will remain open during the third phase P3.

As in the example illustrated in FIGS. 7a and 7b, the resistive element 722 and shunt control switch 724 may be provided as part of the battery pack 910, e.g. coupled between the nodes 928 and 9M6 of the battery pack 910, i.e. in parallel with the plurality of pairs of cell strings 920-1 - 9M0-2.

In the examples described above with reference to FIGS. 5, 7a, 7b and 9, the control circuitry 524 is described as being part of the charging circuitry or device 520. However, in alternative examples the control circuitry 524 may be provided as part of the battery pack 510, 910. Accordingly, the control circuitry 524 is also shown in dashed outline in FIGS. 5, 7a, 7b and 9.

In such alternative examples the control circuitry 524 operates in the manner described above to control operation of the relevant switches 531-1 - 534-N, 924-1 - 9M4-1 of the battery pack 510, 910 (and also to control operation of the shunt control switch 724, if the shunt control switch 724 and resistive element 722 are provided as part of the battery pack 510, as in FIG. 7b). In such alternative examples the control circuitry 524 may also operate in the manner described above control the current source 522 and the switches 724, 726 of the charging circuitry 520, 720, e.g. by transmitting control signals to the current source 522, shunt control switch 724 and/or switch 726 over a connection or interface between the battery pack 510, 910 and the charging circuitry 520, 720.

As will be apparent from the foregoing discussion, the present disclosure provides an improved battery pack and a system and method for charging it which reduces the time required to charge the battery pack without necessitating an increased charging current.

In the forgoing discussion the present disclosure is presented in the context of reducing the charging time of batteries used in electric vehicles. As will be apparent to those of ordinary skill in the art, the principles of the present disclosure are equally applicable to rechargeable battery packs used in other devices, apparatus or applications, e.g. cordless power tools, computing devices such as laptop, tablet and netbook computers, portable devices such as mobile telephones and the like. Thus the present disclosure is not limited to battery packs and associated charging systems and methods for electric vehicles, but extends to battery packs and associated charging systems and methods for other applications, devices or apparatus.

The skilled person will recognise that some aspects of the above-described apparatus and methods, for example the discovery and configuration methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC

(Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-reprogrammable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1-35. (canceled)

36. A battery pack comprising:
a set of N parallel-coupled switched cell strings, each switched cell string comprising a cell and a switch for selectively coupling a first terminal of the cell to a first terminal of the battery pack, wherein the battery pack further comprises control circuitry configured to control the switches of the cell strings to steer a charging current received by the battery pack to the cell of each of the cell strings according to one or more predetermined duty cycles.

37. A battery pack according to claim 36, further comprising a selectable shunt path coupled in parallel with the set of switched cell strings.

38. A battery pack according to claim 37, wherein the selectable shunt path comprises a resistive element coupled in series with a shunt control switch.

39. A battery pack according to claim 36, further comprising a control terminal for receiving one or more control signals to control operation of the switches.

40. A battery pack according to claim 36, wherein the duty cycle is variable based on a parameter of the battery, wherein the parameter of the battery comprises one or more of:
a state of charge of a cell;
a terminal voltage of a cell; and/or
a total accumulated charging time of a cell over a plurality of charging cycles.

41. A battery pack according to according to claim 36, wherein the control circuitry is operable to control operation of the switches of the battery pack such that:
during a first phase of a charging cycle, a cell of a first cell string of the battery pack receives the charging current and a cell of a second cell string of the battery pack receives no charging current; and
during a second phase of the charging cycle, the cell of the second cell string receives the charging current and the cell of the first cell string receives no current.

42. A battery pack according to claim 41, wherein the control circuitry is operable to control operation of the switches such that over a plurality of charging cycles, an average duration of the first and second phases is constant, but the duration of individual first and second charging phases varies.

43. A battery pack according to claim 41, wherein the selectable shunt path comprises a resistive element coupled in series with a shunt control switch, and wherein the control circuitry is operable to cause the switches of the first and second cell string to be open and to cause the shunt control switch to be closed during a third phase, such that the charging current is steered through the resistive element during the third phase.

44. A charging device for charging a battery pack that includes a set of N parallel-coupled switched cell strings, each switched cell string comprising a cell and a switch for selectively coupling a first terminal of the cell to a first terminal of the battery pack, the charging device comprising:
a current source configured to output a charging current; and
control circuitry configured to control the switches of the cell strings to steer the charging current to the cell of each of the cell strings according to one or more predetermined duty cycles.

45. A charging device according to claim 44, wherein the duty cycle is variable based on a parameter of the battery, wherein the parameter of the battery comprises one or more of:
a state of charge of a cell;
a terminal voltage of a cell; and/or
a total accumulated charging time of a cell over a plurality of charging cycles.

46. A charging device according to claim 44, wherein the control circuitry is operable to control operation of the switches of the battery pack such that:
during a first phase of a charging cycle, a cell of a first cell string of the battery pack receives the charging current and a cell of a second cell string of the battery pack receives no charging current; and
during a second phase of the charging cycle, the cell of the second cell string receives the charging current and the cell of the first cell string receives no current.

47. A charging device according to claim 46, wherein the control circuitry is operable to control operation of the switches such that over a plurality of charging cycles, an average duration of the first and second phases is constant, but the duration of individual first and second charging phases varies.

48. A charging device according to claim 46, wherein the control circuitry is operable to control operation of the switches of the battery pack such that:
during a third phase of the charging cycle, the cell of the first string and the cell of the second string receive no charging current.

49. A charging device according to claim 48, wherein the control circuitry is operable to cause the current source to act as a current sink during the third phase so as to partially discharge the cells of the first and second cell strings through the current source during the third phase.

50. A charging device according to claim 44, wherein the charging device further comprises a selectable shunt path, wherein, in use of the charging device, the selectable shunt path is coupled in parallel with the cell strings of the battery pack.

51. A charging device according to claim 50, wherein the selectable shunt path comprises a resistive element coupled in series with a shunt control switch.

52. A charging device according to claim 51, wherein the control circuitry is operable to cause the switches of the first and second cell string to be open and to cause the shunt control switch to be closed during the third phase, such that the charging current is steered through the resistive element during the third phase.

53. A charging device according to claim 51, wherein the control circuitry is operable to cause the switches of the first and second cell string and the shunt control switch to be closed during the third phase, so as to partially discharge the cells of the first and second cell strings through the resistive element during the third phase.

54. A charging device for charging a battery or a battery pack using a pulsed current charging scheme, wherein the device is configured to output a constant charging current over the duration of a charging cycle period.

55. A host device comprising a battery pack according to claim 36, wherein the host device comprises an electric vehicle, an electric bicycle, a wheelchair, an electric scooter, a cordless power tool, a computing device, a laptop, notebook or tablet computer, a portable battery powered device, a mobile telephone or an accessory device for such a host device.
